(19) United States
(12) Patent Application Publication
(10) Pub. No.: US 2002/0049535 A1
(43) Pub. Date: Apr. 25, 2002

(54) Wireless interactive voice-actuated mobile telematics system

(76) Inventors: Ralf Rigo, Liverpool, NY (US); S. Wayne Sanders, Peachtree City, GA (US); Preston Diamond, Chapel Hill, NC (US)

Correspondence Address: Bernhard P. Molldrem, Jr., 333 East Onondaga Street, Syracuse, NY, 13202, US

(21) Appl. No.: 09/927,927

(22) Filed: Aug. 10, 2001

Related U.S. Application Data
(63) Continuation-in-part of application No. 09/399,392, filed on Sep. 20, 1999, now abandoned.

(51) Int. Cl. G01C 21/34

(52) U.S. Cl. 701/211; 701/213; 455/436

(57) ABSTRACT

A wireless interactive voice-actuated mobile information system permits a motorist to obtain information and assistance, hands free, using voice technology and the Internet. An on-board telematics unit in a motor vehicle connects using wireless (cellular) communications with the Internet while the vehicle is underway. A G.P.S. locating circuit is coupled to the on-board telematics unit. An interactive voice net off board station is connected via Internet to communicate wirelessly with the on-board unit. Commercial subscribers including, restaurants, hotels, etc., maintain a connection to the central station. The on-board computer communicates the geographical position and direction of travel to central station to obtain restaurant or hotel information, which the telematics unit communicates using voice technology with the person in the vehicle. The person can make and confirm lodging and communicate payment data to a selected restaurant or hotel. The system operates unattended at the subscriber end.

### RELATED APPLICATION DATA

This is a continuation-in-part of copending application Ser. No. 09/399,392, filed Sep. 20, 1999.

### BACKGROUND OF THE INVENTION

This invention relates to voice navigation and information systems for travelers, such as motorists or other motor vehicle operators, and is more particularly concerned with a system that can direct a motorist to a restaurant, hotel, motel, state park, retailer, or other hospitality facility, using wireless communications and the Internet. The invention also concerns telematics, i.e., hands-free automated communication of data between an on-board or in-vehicle computer device and a computer or server at a service provider.

A number of wireless motor vehicle navigation systems have been proposed, and some of these employ voice or speech technology so that a driver of the vehicle does not have to use his or her hands to communicate nor does the driver have to take his or her eyes off the road to get information.

Voice-type navigation systems for motor vehicles are described, for example, in U.S. Pat. No. 5,4406,492 to Suzuki, and in U.S. Pat. No. 5,177,685 to Davis et al.

Sulich et al. U.S. Pat. No. 5,875,412 relates to a wireless navigation and route guidance system for a vehicle, with an on-board navigation computer. The computer communicates with a central processor. The arrangement of the Sulich et al. patent relates geographical coordinates, i.e., latitude and longitude, to street addresses and phone numbers. The Sulich et al. arrangement can also dispatch routing information for a truck or fleet vehicle.

Goldberg et al. U.S. Pat. No. 5,742,509 relates to a personal tracking system using an intelligent tracking system, such a global positioning satellite technology, plus cellular links to the system data base. The mobile unit updates the central station every so often as to the vehicle's whereabouts. The Goldberg et al. system requires a so-called WATSON device.

Other prior patents concern various aspects of computerized vehicular navigation. Nimura et al. U.S. Pat. No. 5,890,088 relates to a map display system. Schulte et al. U.S. Pat. No. 5,736,941 concerns a land vehicle navigation device using speech messages to communicate with the driver. Kaneko et al. U.S. Pat. No. 5,729,109 also employs voice guidance for navigation, and provides the driver with route information based on stored map data and G.P.S. positioning information. Eldridge U.S. Pat. No. 5,717,392 concerns a vehicle direction and control system with a multi-media output that can be used as an automated tour guide. Reynolds U.S. Pat. No. 5,677,837 concerns a mobile position determination system that compares actual position with a destination position, using a “position comparator.” Kishi et al. U.S. Pat. No. 5,410,486 concerns a system that employs a voice vehicle navigation system, and issues oral route guidance based on the vehicle's position and motion situation. Schuchman et al. U.S. Pat. No. 5,365,450 concerns a G.P.S.-based locator system for use in an “urban canyon” environment where there is a limited line of sight to the constellation of navigation satellites; Schuchman et al. merges G.P.S. and wireless telephone systems to obtain the 900-bit G.P.S. satellite data message over the wireless system instead of directly from the satellite.

DeLorme et al. U.S. Pat. No. 5,948,040, describes an automated trip planning system with a reservation capability, for which, in a preferred embodiment, a so-called TRIPS provider is used, which is DeLorme's proprietary third-party travel reservation service. DeLorme's process of making reservations, either from the fixed computer arrangement or from a mobile facility, is described as making reservation information and materials associated with services or goods available from one or more travel service providers which can either be a third-party provider, i.e., a travel agency, or from its TRIPS provider functionality. Requests for lodging or restaurant services are handled through a TRIPS service bureau where a third party negotiator functionality is included in between the individual in the vehicle and the target restaurant or hotel. Any follow-up dialog between the user and the hotel or restaurant is also through the TRIPS provider. That is, a third-party negotiant is involved. The person in the vehicle does not communicate over the Internet directly with the hotel (or restaurant). In addition, DeLorme does not contemplate communicating directly with the hotel or restaurant computer system, so that the service provider generates information, reservations, and confirmations automatically without human intervention at the provider end.

To date, no one has proposed a voice-actuated system that can provide the motorist with relevant information concerning hotels or restaurants in the vicinity, contact the hotel or restaurant and obtain up-to-date menu, rate, room availability, or other such information, or make a reservation at the restaurant or hotel for the motorist, and confirm the reservation automatically over the Internet. Currently, the motorist has to rely on travel guides or on-line travel services, which may or may not have the most recent information, and which may not provide accurate driving directions to reach the location of the hospitality facility. Conventionally, on-line travel services require an attendant, i.e., human interaction, at the hotel or restaurant end. Otherwise, the traveler is limited to roadside fast-food facilities and to motels that are adjacent the exits for the major highways. Also, if the traveler should need automotive repair, a repair facility be very difficult to find and it is difficult to make repair arrangements while on the road.

Telematics, i.e., transport telematics or mobile telematics, have recently come into play. Telematics employs modem telecommunications technology to assist travelers, trucking operators, or other transport operators in efficient travel, increased efficiency and productivity, and reduced driving times through optimized route selection and congestion avoidance. There has been recent interest in assisting hospitality providers in optimal pricing to achieve higher fill rates and to reduce waiting times at hotel/motel check in, for example. Ideally, telematics could provide a hotel or motel reservation and confirmation function that could be carried out directly between a hotel Internet function, through the hotel's property management system or reservation management system, and the automotive on-board computer. In such case, the system could avoid the need for attended operation, i.e., require human intervention, at the hotel end, as the entire transaction can be handled between the hotel Internet computer and the automotive on-board computer. Likewise, a Restaurant Management System, in the restaurant's Internet-connected computer, can communicate directly and unattended with the automotive on-board computer.

### OBJECTS AND SUMMARY OF THE INVENTION

Accordingly, it is an object of the present invention to provide a voice interactive wireless information system for the benefit of motorists and other travelers, and which overcomes the drawbacks of the prior art.

It is another object to connect the traveler with available services within a reasonable driving distance and in the direction in which he or she is traveling.

It is a related object to provide a system that can provide the motorist with up-to-the-minute lodging availability, pricing details, special offers, menu information, and other related information.

It is another related object of the invention to provide a system by means of which many restaurants, hotels, and other hospitality providers, as well as shopping malls, state parks, and other facilities, can make their services available to a much broader clientele.

It is a further object to provide the motorist with better driving directions to a facility that the motorist selects than is currently available.

It is also an object to provide the information to the motorist without requiring the motorist to take his or her eyes off the road, and without having to use his or her hands to actuate any of the computer equipment.

In accordance with one aspect of the present invention, a wireless interactive voice-actuated mobile information system employs an on-board computer installed in the motor vehicle with cellular phone service or similar wireless technology to connect to the Internet while said vehicle is underway. A voice technology circuit coupled with the computer permits the computer to communicate with a person in the vehicle, i.e., the driver or operator, and converts spoken commands uttered by the person to electronic commands to be used in the computer. A speaker and microphone are coupled to the voice technology circuit. A G.P.S. or G.B.P.S. locating device is coupled to the on-board computer and provides the computer with real time geodetic positioning information. There can be inputs connected with the speedometer and odometer, and to a compass to obtain speed, distance, and direction information.

An interactive voice net central station is connected via the Internet and communicates over the wireless system with the on-board computer in the vehicle. Meanwhile, a number of commercial subscribers are also connected, via the Internet, to the central station, and these may include a plurality of hospitality providers whose location is known relative to one or more principal roadways. Each of the subscribers maintains an Internet connection with the central station and can provide up-to-date information for the travelers that have the system installed on their vehicles. The central station has a capability for querying the on-board computer of the vehicle in question to obtain the geographical position and direction of travel of that motor vehicle. Then the central station can communicate via the voice technology circuit with the person in the vehicle to receive commands from him or her and to provide information and questions to him or her. Then the central station conveys the requested information, including any desired hospitality reservation information between one or more of these commercial subscribers and the motorist hands-free.

At the hotel, restaurant, or other commercial subscriber, room selection (or menu selections) reservation, and payment are handled automatically by the computer system, i.e., the Central Reservation System (CRS), Property Management System (PMS), or Restaurant Management System (RMS). The information and reservation functions are carried out without a man-machine interface, i.e., without requiring a human host, hostess, clerk, or concierge to confirm or enter any of the reservation information.

The wireless interactive system can connect the traveler with available services such a lodging, food, automotive repair, medical care, shopping malls, special attractions, or state or national parks. As to lodging, up-to-the-minute lodging availability is conveyed to the motorist, giving prices, accommodation details, special offers, and the like. The individual motorist can then make the reservation, if desired, from the vehicle. This eliminates the need to make several stops to find last-minute accommodations, and also gives the provider contact with more travelers and thus a higher chance of filling his rooms. Automotive repair services can be selected on the basis of availability, make of automobile, and other information. Maintenance scheduling and preparation of the appropriate work order can be done automatically in the repair service facility's computer. The selection of restaurant can be much broader than what is now available to the motorist traveling through. The motorist will no longer be limited to fast food restaurants located at Interstate Highway exits. It is possible for the motorist to contact a restaurant using this system even while a ways distant, obtain the restaurant's menu information and make reservations if desired, after which the system will provide the motorist with a voice reservation confirmation message. The reservation information will be automatically transmitted to a facility in the restaurant and kitchen, so that the motorist's meal and seat at table will be ready upon his arrival.

In this invention, a wireless interactive voice recognition, text-to-speech, speech-to-text, and/or Smartcard actuated automobile/vehicle based information, reservation booking, and point-of sale system permits a person, i.e., motorist, to identify, reserve, and purchase lodging accommodations, as well as associated meal, hospitality and travel services (i.e., restaurant reservations, amusement park tickets, airport parking, golf tee times, vehicle commerce coupons such as fuel or car wash, etc.). The transaction process for the motorist to identify, reserve, and purchase provider services are conducted in real time and hands free, or virtually hands free. Herein, lodging accommodations and associated hospitality and travel service providers are considered as “providers” or “subscribers”, and the persons who operate the system can be motorists, occupants of hotel rooms, diners, or travelers, but the terms “persons” and “motorists” are intended to cover all these generally. The term “Smartcard” is used here to include other equivalent technologies as well, such as smart cell phone and PDA technology.

In this invention, as disclosed and described herein, the vehicle on-board computer serves as the vehicle's telematics unit, with interactive voice recognition for actuation of the off-board computing system at the central or control station, with features such as speech-to-text, text-to-speech, Smartcard, Personal Digital Assistant (PDA), Global Positioning Satellite (GPS), ground-based positioning system (GBPS), and associated input media. In-vehicle input-output channels can be connected to the telematics unit either through an integrated circuit, wireline connection, and/or short wireless connection (such as Bluetooth). Smartcard refers to card media, typically compliant with American Banking Association (ABA) credit-card design standards, and which is embedded with a processing/storage microchip. The Smartcard can be utilized independently, or in connection with another card technology such as magnetic strip, bar code, and/or proximity, i.e., as a multi-media card. The system connecting the off-board and subscriber facilities can include wirelines, wireless systems, the Internet, software, electronic hardware, network circuits, i.e. WANs and LANs, and includes the databases necessary to execute the input, processing, and output of commands and data. The invention may employ multiple input and output channel options that provide motorists with the flexibility to select system operating preferences to create a personalized, hands-free or virtually hands-free, human interface with the system.

A vehicle that is underway and is equipped with a telematics unit of this invention, i.e., with the associated circuitry and devices for input, processing, output, and display of information and/or data, allows the motorist to connect to the Internet using wireless communication technology. A coupled interactive voice recognition circuit converts spoken commands uttered by the motorist to electronic commands that are processed by the telematics unit to actuate the unit and off board computing system. A coupled GPS or GBPS circuit supplies location data that are processed by the telematics unit and transmitted to the off board computing system. Coupled auxiliary devices or circuits allow Smartcards, PDAs, smart cell phones, and/or a printer to be linked via wireline or short-range wireless with the telematics unit to aid the motorist in the inputting, receipt, storage, and retrieval of information. A coupled cell phone circuit provides a wireless two-way communication connection between the telematics unit and the off board computing system. The connection is established via a wireless application gateway network device and a wired Internet connection that can process both voice and electronic data commands. The off board computing system application server and message queuing feature manages voice-to-speech, as well as text/graphic, geonavigation, Smartcard, wireless interface, central reservation system (CRS) interface, and consumer/client information input functions. An application protocol adapter (APA) network device connects the off board computing system to the provider's electronic proprietary central reservation system. The necessary provider services information, data (e.g., room rate), reservation booking software, and point-of-sale software resides on the provider's proprietary central reservation system.

When the motorist requests information, the off board computing system obtains the requested information from the provider's electronic central reservation system (where the provider is a hotel chain) or from the provider's property management system (where the hotel is independent), and converts the information into a format, i.e., speech, text, graphics, that can be transmitted to the vehicle's telematics unit. The interface between the off board computing system and the provider's central reservation system is electronic exclusively—this is unattended, and there is no interaction with a human employee or agent, as there would be in the case of a call center, travel agency, or other conventional reservation center. In other words, the entire transaction process is entirely executed electronically, with the exception of the in-vehicle motorist/telematics interface.

The off board computing system, via the two-way wireless communications connection, can query the vehicle's telematics unit for geographical position and direction of travel. Once the position and direction of the vehicle are transmitted and received by the off board computing system, the requested provider services information, within the geographical area in the zone ahead of the vehicle's position, can be obtained from the interconnection with the central reservation system(s), converted by the off board computing system and delivered using speech, text, and/or graphics to the vehicle's on board telematics unit. The on board telematics and associated output channel circuits can convert the electronic data and commands into a speech, text, print, e-mail, visual display media for the vehicle's occupants, or some combination of the same. After the motorist and/or vehicle occupants select the provider services that he, she or they desire, they can initiate the booking of a reservation and complete a point-of-sale transaction (i.e., purchase) in real time. Directions to the provider location will be presented to the motorist using speech, text, printer, visual display, or some combination of these. As an alternative to a typical credit card transaction, an optional Smartcard, PDA, and/or smart cell phone circuit can be coupled with the on board telematics unit to facilitate the point-of-sale transaction. A Smartcard interface also allows a consumer to check into Smartcard equipped lodging establishments, either using a kiosk in the hotel lobby for room assignment and key coding functions, or else bypassing check-in points altogether and providing guest room access directly using the Smartcard, PDA or smart cell phone.

Other providers may be equipped with Smartcard, PDA, and/or smart cell phone enabled transaction systems, permitting them to complete point-of-sale transactions at their establishments. The providers can log into the system's server via the Internet to continuously update their respective database(s). For example, a lodging provider can continuously update a description of accommodations, room availability, standard room rates, vehicle commerce specials, discount coupons, special instructions, and advertising/marketing messages. For example, restaurants can provide menus, vehicle commerce specials, and advertising marketing messages. The system's advertising message feature will enable providers to create marketing alliances with other providers in a given geographical area, and to have advertising messages delivered with a response to a request for information and booked reservation and/or point-of-sale transaction confirmation.

Consumers, including travelers, motorists, etc., can log into the system's server via the Internet to create a personalized consumer preference profile. For example, the consumer can specify a preferred lodging company, restaurant system, attraction, gasoline brand, etc. The consumer preference profile and service provider databases may be relational so that only preferred information will be transmitted to the consumer's vehicle. Consumers can select on-demand or tracking modes when traveling. On-demand mode will only deliver provider information when requested by the motorist. Tracking mode will continuously and automatically deliver geographically specific information as the motorist is traveling (this can be personalized to the consumer preference profile).

The wireless interactive voice recognition, text-to-speech, speech-to-text, and/or Smartcard actuated automobile/vehicle based information, reservation booking, and point-of-sale system can be deployed nationwide, and even globally or internationally. To accomplish international deployment, the data input and output channels can be multi-lingual-enabled. The system preferably employs an “open” architecture and standards, so data can be exchanged and synchronized (uploaded/downloaded) with desktop, laptop, pocket, and palm classes of computers, including personal digital assistant devices (PDAs) and Internet-enabled cell phones.

Other advantages are possible, which ensue from the direct Internet connection between the Internet-connected computer at the lodging provider, for example, and the automotive on-board telematic computer. With this system, the hotel or other lodging provider can now provide the arriving motorist with a room number for the assigned hotel or motel room, so the motorist can proceed upon arrival directly to his or her room. This allows the motorist, who may be fatigued, to avoid waiting in line at the front desk. It also permits the hotel, using available technology, to provide a room-key code so the on-board computer may create a card room key, e.g., through an associated Smartcard or mag-card device. This device may be easily miniaturized to fit in the car's dashboard. The room keycard creation process may be accomplished in real time or very near real time, so that the hotel can make and confirm a room reservation and then create a room key card for the motorist even as he or she is arriving at the hotel. Also, credit card information, necessary for reservation purposes, can be exchanged directly between the motorist and the hotel, and is not shared with the Internet central station or off-board facility. The motorist's credit card information can be stored in the vehicular on-board computer, or else the motorist can simply swipe the card through a card reader in the vehicle. The credit card information does not need to be stored at a third-party location, such as with a travel agent or a TRIPS provider, as is done in some earlier systems, which require human intervention. This minimizes the possibility of compromise of the motorist's credit information, and of Internet credit-card fraud, e.g., “hacking”.

Another advantage of the system of this invention is that the hotels or other participating service providers can communicate up-to-the-minute room availability and price structure, which may vary during the day depending on the hotel's fill rates, last-minute cancellations, and other factors. That is, by using a pricing program that takes into account the time of day, number of unsold rooms, vehicular traffic density, and other factors, the lodging provider can change room prices in real time to optimize the hotel room fill rate. The rates can change on a real-time basis, and can then be immediately made known to travelers in the vicinity via the on-board telematic system. This also ensures that the traveler is presented with a fair competitive room rate. Importantly, because there is no “middle-man” involved at this stage, there is no commission, which is usually a percentage of the room charge. With the conventional third-party travel reservation system, the tariff added by the third party provider would limit the flexibility of the hotel, motel or other lodging provider in filling rooms, as the hotel would not be able to offer really low, competitive rates for soon-arriving Internet travelers. By contrast, in the system of this invention, the hotel, lodging provider or other hospitality provider facility is a subscriber, and can participate, for example, for a fixed monthly fee. The central station, i.e., off-board server is not involved in negotiating or confirming a reservation, as that is carried out directly between the subscriber hospitality facility and the traveler in the vehicle. Once the interactive voice net central station, i.e., off-board server, has connected the hotel computer to the automotive on-board telematics computer, the two ends, i.e., the motorist and the lodging provider, make their transaction directly.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWING

FIG. 1 is a schematic view of a wireless interactive mobile information system according to an embodiment of this invention.

FIG. 2 is an elevation showing the dashboard of a motor vehicle having an on-board telematics arrangement as a portion of the system of this embodiment.

FIG. 3 is a schematic diagram of a the on-board computer arrangement of this embodiment.

FIG. 4 is a macro system diagram explaining the interconnections of the on-board automotive system, the off-board computing system, and the subscriber electronic information, reservation and confirmation systems.

FIG. 5 is a diagram explaining details of the subscriber end of the system.

FIG. 6 is another diagram explaining details at the subscriber end.

### DETAILED DESCRIPTION OF THE PREFERRED EMBODIMENT

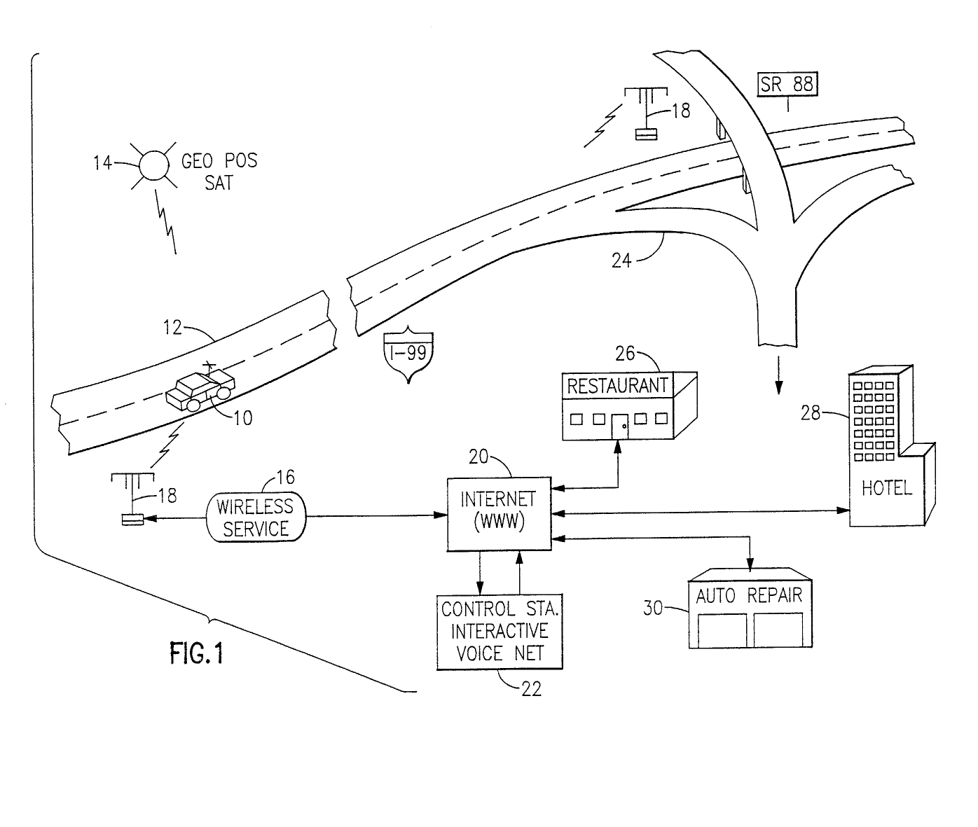

With reference now to the Drawing, an initially to FIG. 1, a motor vehicle 10, i.e., a passenger car, is seen proceeding along a thoroughfare 12, here for example an Interstate limited-access highway. Of course, the invention is not limited to cars and trucks, but could be applied in aircraft or watercraft, without varying the principle of the invention.

A global positioning satellite 14 is shown on a line-of-sight path from the vehicle 10. Normally there would be a cluster of three or more satellites which permit the vehicle 10, using onboard equipment, to obtain its exact location.

A wireless, i.e., cellular phone service system 16 connects with the motor vehicle 10, here by means of antenna towers 18 positioned at points along the thoroughfare 12, ideally, so that the vehicle is always within range of a tower. In this case the wireless service 16 connects to an Internet provider 20, which connects the motorist in the vehicle 10 to the global computer network, known as the Internet, including a central station 22 that provides interactive voice mobile information to the motorist, over the Internet. A number of commercial or other hospitality service providers, such as hotels and restaurants, and other service facilities such as parks, theaters, automotive repair facilities, etc., may also be subscribers to the interactive voice net through the central station 22. Here, a number of facilities are shown in the vicinity of an exit or crossroads 24 in the direction the vehicle is heading along the thoroughfare 12, in this example, a restaurant 26, a hotel or motel 28, and an automotive repair shop 30. Each of these subscriber locations is connected via the Internet 20 to the central station 22, and each one provides up to the minute information about its services and prices.

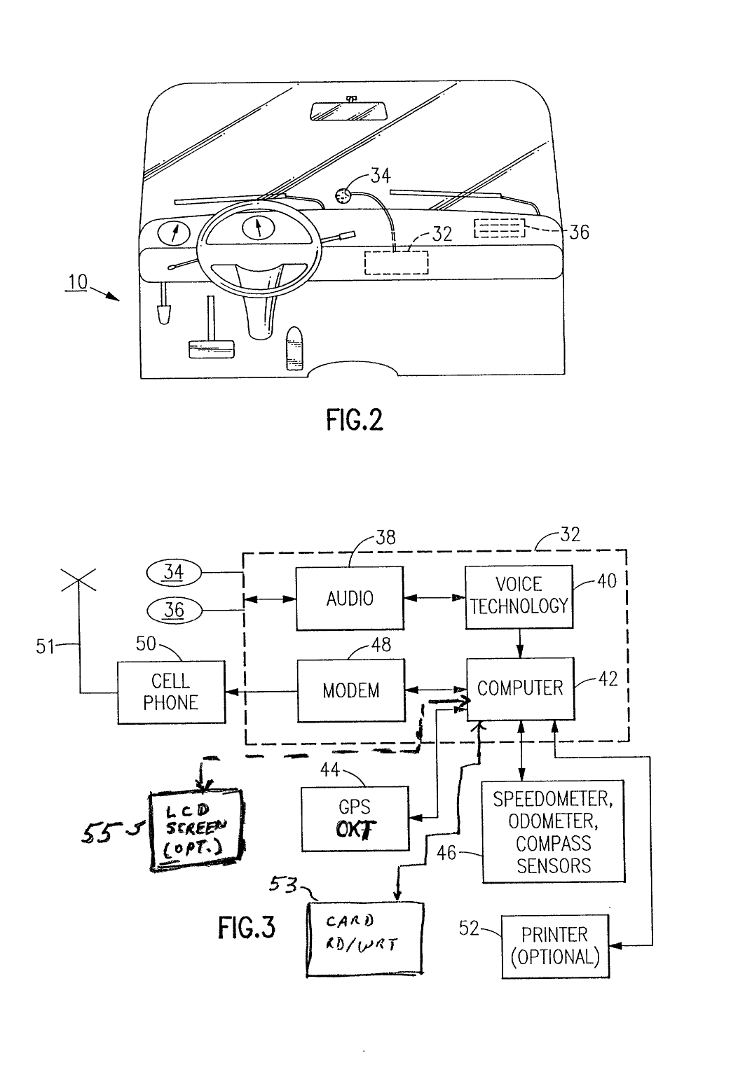

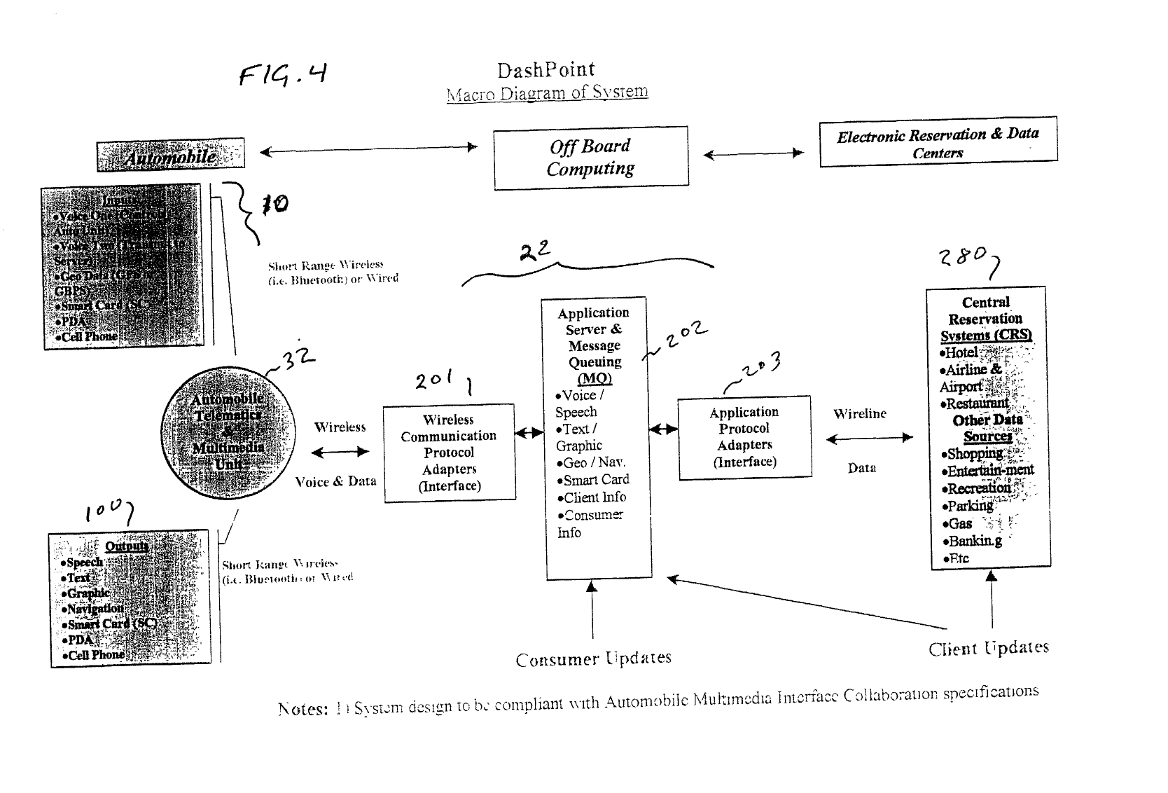

FIG. 2 shows the interior arrangement of the vehicle 10, in which an on-board telematics unit 32 fits compactly into a space in the vehicle dash near the radio/tape/CD player, and is connected to audio transducers including a microphone 34 to pick up the driver's voice, and a speaker 36. As shown in FIG. 3, the on-board telematics unit 32 includes an audio circuit, i.e., an audio card, that connects with the audio transducers 34, 36, voice technology 40, and a dedicated on-board computer 42 that is capable of Internet access. The voice technology may be a voice circuit or card, or alternatively may consist of software within the computer 42. As also shown here, a G.P.S. circuit 44 obtains satellite positioning data and feeds that to the computer 42. Sensor inputs 46 connected with the speedometer, odometer, and compass provide the computer 42 with input data about the location, speed, and bearing of the vehicle 10. A modem 48 connects the computer 42 with a cellular phone module 50 that connects with the cellular or wireless network 16 through an antenna 51 on the vehicle. A printer 52 can print out information, such a directions to one of the hospitality facilities, if the driver commands the computer to print. As also shown, the on-board telematics unit can be coupled to a card read/write module 53, which can favorably be a Smartcard device. This module can be miniaturized to fit into the dash or console of the vehicle. A Smartcard can be inserted into the module 53, to permit readout of data on a microchip embedded in the Smartcard, and to permit data to be written onto the Smartcard. Alternatively, the module 53 may be a magnetic card read/write device for writing encoded data onto a magnetic stripe of a standard mag-stripe card. This device may also be used for entering the motorists credit card account information into the on-board computer. In either case, the Smartcard or magnetic stripe card can be encoded with hotel room key code information, so that the on-board computer may create a room key for the motorist, thus avoiding delays associated with hotel or motel check-in. In some preferred arrangements, the printer 52 may print out a coded PIN number for room entry, or may print out a slip with a bar coded symbol for that purpose. An optional LCD screen 55 may be included as an output to display map or information about the subscriber hospitality provider. This may be touch screen technology to permit motorist (or passenger) input of data.

The operation of the voice-actuated mobile information system involves a human interface only between the person in the vehicle and the on-board computer system, with the computer equipment at the central station and at the subscribers automatically carrying out their information services and reservation services. This simplifies the entire system operation, which may be generally described as follows:

The operator of the motor vehicle speaks, in normal voice tones, into the microphone 34, to address the computer, i.e., “Computer, where are we?” or “Computer, what is our location?” and the on-board computer 42 will retrieve location data, or obtain fresh satellite data, and will respond to the operator, for example, “You are proceeding northbound on Interstate 99, five miles from Exit Twelve.” Some of this data may be obtained from the central location over the Internet. Then the system will make a voice query to the operator, “Can I get you anything else?” and if the operator says “No, thank you,” the system will go to idle and await further need. However, if the operator says “Yes, please” the computer will respond, for example, “Would you like a restaurant or hotel?” and then the operator says “Hotel” or “Restaurant.” Then the computer 42 will obtain a list of local hotels within some predetermined driving distance from the present location, e.g., within the next one or two exits on the Interstate. This can be obtained via the Internet connection to the central station 22, which maintains a list of hospitality facilities, which are classified in terms of location, type of cuisine, etc., for restaurants nationwide. Based on the vehicle's location and direction of travel, data for several nearby restaurants are downloaded to the on-board computer 42. Then the computer may ask, “Would you prefer, Italian food, Chinese food, Mexican food, or American?” depending on the types of restaurants in the vicinity. If the operator states “Mexican” then the computer reads the names of one or more Mexican restaurants. If the restaurants are subscribers to the service, then they may have their full menus, prices, and other information available. However, for non-subscribers, only the name of the restaurant, general information, and location may be available. The computer then would ask “Would you like a menu?” and can list the specials and regular menu items, plus prices. The computer then may ask “Would you like me to make a reservation?” and if the operator states “Yes, please,” the computer 42 will connect with the restaurant, via the Internet, and make a dinner reservation, using an estimated time of arrival based on the vehicle's location, and the driving time to the restaurant location. Then, the restaurant will confirm the reservation electronically, and the computer will give the operator a confirmation of the dinner reservation: “Your reservation is confirmed at Pancho's Restaurant at 7:00 PM. Would you like driving directions to Pancho's Restaurant?” If the operator says, “Yes, please,” the computer 42 provides driving directions from the nearest exit to the restaurant location. These are provided in voice form, but if the driver says, “Please print,” the computer 42 will command the small onboard printer 52 to print out the driving directions to the restaurant. The printed instructions are useful if there is a passenger as well as the driver. With this system, the selection of available restaurants is considerably broadened for the traveler. The choice is not limited to fast-food locations at or next to the highway exits. Restaurants can offer their services to travelers even if not located nearby. Also, some restaurants may offer a special price for Internet customers.

This system also greatly facilitates finding lodging for the traveler. The single hotel 28 shown in the drawing represents a number of hotels and motels that may be within some reasonable driving distance of the vehicle's location. The hotels may be individual or independent hotels, or may be part of a hotel corporation or franchise. Each of these hotels would be connected via the Internet to the central station 22, and each of them would make available current up-to-the-minute lodging availability and pricing, accommodation details, special offers, and the like. The traveler can then choose from a number of providers, and can find accommodations without having to stop and hunt. The voice commands and responses for hotel selection are similar to those described above for restaurants. The system of this invention eliminates the need of making several stops to find last-minute accommodations. On the other hand, each of the hotels and motels makes its services available to a broader range of participating motorists, and thus increases the probability of filling its room vacancies. Additional information may be exchanged with the restaurant as well, such as seating preference, and number of diners in the party.

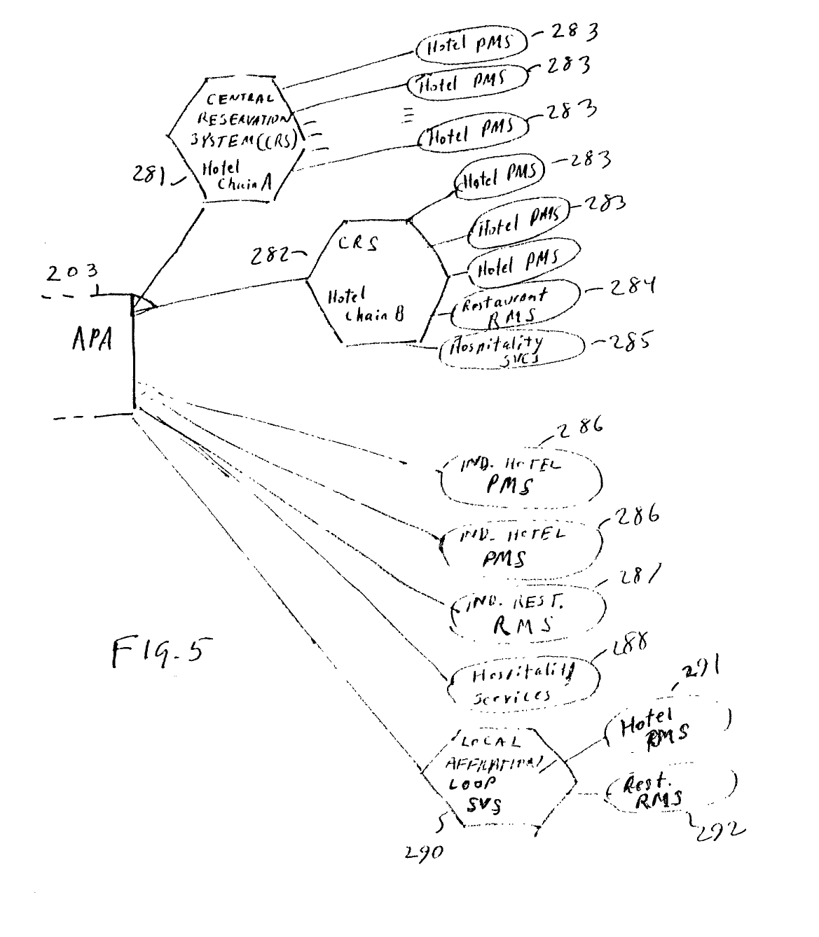

The means for interconnection of the central station with the various subscriber hospitality service providers is described in more detail with reference to FIGS. 4, 5, and 6.

FIG. 4 is a schematic block diagram showing the relationship of the on-board automotive system 10, including the telematics unit 32, to the central station or off-board computing system 20, and to the hospitality provider subscribers, e.g., through a computerized central reservation system associated with each given provider.

Within the automobile or other vehicle system 10 are various input functionalities associated with the on-board automated telematics and multi-media unit 32, including a Voice One input for controlling the automotive on-board computer 42, a Voice Two input for communicating with the off-board server, a geo-data unit such as GPS or GBPS, a Smartcard (SC) device 53, and connections for a PDA and cell phone. There are also output functionalities 100, including voice or speech, text, graphics, navigation, Smartcard, PDA and smart cell phone.

The telematics unit 32 connects wirelessly to carry voice and data between the unit 32 and a wireless communication protocol adapter 201 at the off-board computing facility or central station 22. This connects with an application server and message queuing (MQ) functionality 202, including voice/speech, text/graphics, geo/navigation, Smartcard interface, and storage of client (subscriber) information and consumer (motorist) information. The consumer information can include customer profiles that are entered by the consumer through Internet access, and can include preferences as to hotel chains, types of restaurants, etc., which facilitates locating and obtaining meals and lodging en route. The hotels, restaurants, and other subscribers and commercial participants can update their own profiles also, although specifics such as menus, room availability, and real-time pricing is usually carried out at the subscriber facility. An application protocol adapter 203 connects, here with a permanent wired data connection, between the application server 202 and the automated computer facility at the subscriber location 28, here represented as a Central Reservation System or CRS 280. The CRS can be associated with a hotel or group of hotels, airline or airport, or restaurant. The CRS 280 can access other data sources associated commercially or geographically with the hotel properties, e.g., shopping, entertainment (movies, theater, etc.), recreation, parking, fuel and vehicle repair, banking, and other similar businesses. The hosting hotel will typically update its CRS 280 on a daily basis or more frequently, and can update on a real time basis as to room availability and pricing.

The traveler, i.e., motorist, can choose between the on-demand mode and the tracking mode either by either using the voice feature of the telematics unit to switch between modes, or by changing his or her customer profile, which is stored at the off-board computer facility. As mentioned before, in the on-demand mode, the off-board computer provides hospitality subscriber data only upon a request initiated by the motorist, and in the tracking mode, the off-board computer provides and delivers data continuously, supplying data from subscribers in the geographical area in which the motorist is traveling.

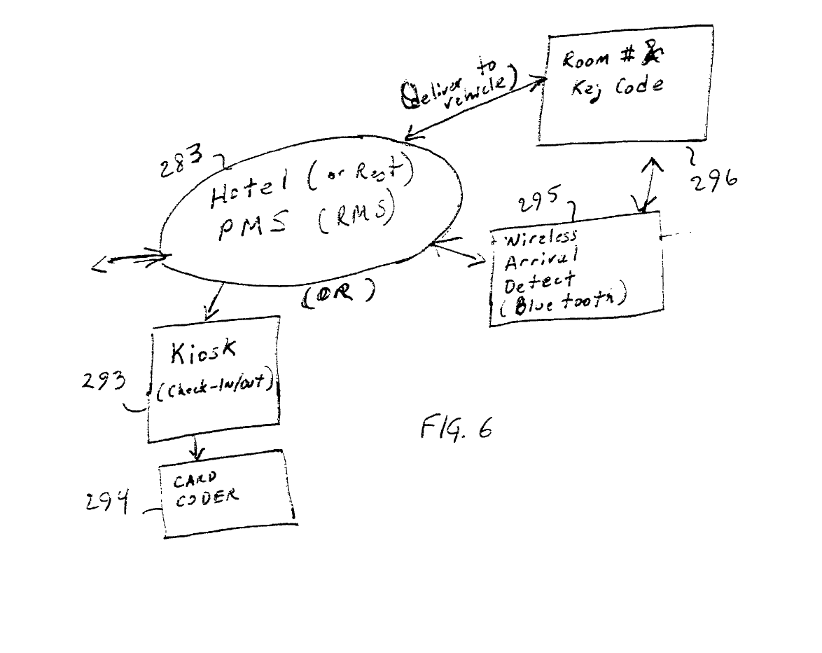

The connection of a large number of subscribers, which may be multiple-property hotel chains, stand-alone hotels, restaurants, or other hospitality service providers, is shown schematically in FIG. 5, which represents detail on the right hand side of FIG. 4. Here, the application protocol adapter(s) 203 at the central station 22 are wireline-connected to a central reservation system computer 281 or CRS, for a first hotel system, here Hotel Chain A. The same or another APA 203 is also wireline connected to a second CRS 282 associated with another system, Hotel Chain B. Each participating hotel chain or other service provider would have its central reservation system communicating through an APA with the central station 22, although only two CRSs are shown here. The CRS 281 for the Hotel A Chain is connected to a respective property management system 283 at each of the individual hotels in its system, and is kept up to date in real time or near real time as to room availability, occupancy rates, and other relevant data about each particular property. The term “property” here is understood to be a hotel or motel in a particular location, and there may be one or more than one property in a given locale. The CRS 282 for the Hotel B Chain is likewise connected to the property management system computers 283 at each of its own respective properties. This may also be connected with a restaurant computer, i.e., a restaurant management system 284, which may be located at one of the Hotel B properties, or may be free-standing. The CRS 282 may also connect with a service management computer system 285 at an affiliated hospitality service provider, e.g., a theme park, entertainment provider, etc.

For subscribers which are independent hotels that are not part of a system, the application protocol adapter(s) may be wireline connected to the individual hotels' property management systems or PMS 286. Likewise, the APAs 203 may connect with a restaurant management system computer 287 for an independent restaurant subscriber, or to a management system computer 288 for another, i.e., miscellaneous hospitality service provider. At the lower part of FIG. 5 is shown a local affiliation server 290, which may be operated by a local affiliation cooperative (e.g., local chamber of commerce) on behalf of local service providers. In this example, the local affiliation server computer 290 is wireline connected to a local hotel PMS 291 and a local restaurant RMS 292, and is also wireline connected to an APA 203 of the central station 20. In this case also, hotel and restaurant occupancy and availability data as well as menu and pricing can be updated automatically and in real time, and provided to the server 290.

The automated check in and room keycard coding can be explained with reference to FIG. 6. Here, when the motorist who had accomplished the reservation function with respect to a given hotel, i.e., hotel property, arrives on premises or is approaching the hotel property, one of several alternative techniques can be used, two of which are explained here. In one alternative, the hotel property management system 283 can be connected to an on-premises automated check-in kiosk 293. Here, an automatic card coder 294, which can be unattended, provides the arriving motorist with a magnetic keycard, Smartcard key, or other coded entry device. Here, the motorist may be required to enter a PIN or other code that was transmitted to his vehicle and printed out, or to present a bar-coded receipt, printed out in his vehicle, to a reader in the kiosk 293. Alternatively, a wireless arrival detection mechanism 295 can be employed, e.g., a short range radio or Bluetooth system, which detects when the motorist/guest's vehicle has driven onto the premises. At that time, the hotel PMS generates codes for the motorist's room number and also a key code, which it transmits to the vehicle, either back through the off board computing system at the central station 22 to the vehicle on-board telematics unit 32, or else from the short range wireless or Bluetooth system directly to the vehicle telematics unit 32. At this point the automotive on-board unit 32 can communicate with the device 53 for coding the Smartcard or mag card for entry to the motorists room. Alternatively, the room number and key code and be loaded onto a PDA or smart cell phone to access the motorist's lodging space. This system permits bypass of the entire check-in function, and allows the motorist to proceed directly to the lodging space he or she has reserved.

If the motorist is in need of automotive repair services while en route, they may be obtained, with the selections being made on the basis of location, availability, make of automobile, and so forth. In this case, if the motorist says, “Computer, I need a mechanic,” the system will find a list of the nearest available garages, car dealers, and repair shops. The repair shop can be automatically contacted via Internet, and can be provided with the vehicle's estimated arrival time, plus any diagnostic information that can be obtained from the vehicle's on-board diagnostics equipment. The garage computer make scheduled repair arrangements automatically with the vehicle which en route, and also may be able to order automatically any needed replacement parts for the specific vehicle, so that the parts are on hand when the vehicle arrives. This keeps down time to a minimum for the traveler. In the case that roadside assistance is needed, the repair service may be provided with the identity and location of the vehicle, and may reply back with the identity and expected arrival time of the emergency road service provider. Insurance or other payment information may be exchanged automatically, as well, to facilitate getting the motorist underway.

The computer 42 can also be used for many standard functions as well, such as the operator's e-mail messages. If the operator speaks a command, “Please, check my e-mail,” the computer will retrieve a list of messages not yet read. Then if the operator says “Please, read my e-mail,” the computer will read each message in turn. The operator may reply to any of these messages using the commands “Reply” and “Send, please.” The replies may be text or audio (.wav) format.

The operator may also use this system for phone connections, using such commands as “Call my Office,” or “Call Bob.” For possible emergencies, if the operator uses the command, “Please dial Nine-One-One,” the off-board computer at the central station 22 tracks to find the nearest 911 or similar emergency facility to the vehicle location, and then connects with that facility. The system can provide the emergency service with the vehicle identification and location information. Furthermore, the system may keep track of the user's appointments, and give out reminders, as need be, as voice or speech messages.

Not only restaurants, hotels, and garages, but other providers may also advertise and offer information over this system. This may include shopping malls, theme parks, special attractions, state parks, beaches, and golf courses. The need for unsightly billboards could be eliminated. Real estate over a wider radius from thoroughfare exits would increase in value. Travelers would have less concern about reaching a particular exit by a given time in order to find lodging or meal services, and this could lead to less erratic and safer driving. Also, the travel directions to a restaurant, hotel, or other attraction will be of better quality than what is obtained though local advice. The driver or operator can keep his or her hands on the steering wheel and his or her eyes on the road, since all communication can be carried out by voice by means of the onboard computer and the wireless Internet connection. Vendors can be connected on a regional, nationwide or worldwide basis through a computerized system capable of handling a great load of traffic and handling it and routing it efficiently. Revenue sources may be by monthly subscription by the motorist, listing and advertising charges to the subscriber hospitality providers, and through software sales and technical support.

Much text-to-speech technology is available, as described in some of the patents mentioned above. However, the invention is not limited to technology that is currently available. Also, the on-board computer 42 and other equipment in the vehicle are not limited to permanently installed equipment, and may include equipment that is removably plugged-in. The system of this invention applies to any portable or hand-held wireless arrangement, including those that can be moved from vehicle to vehicle. A plug-in telematics unit can be rented when needed, or may be a package feature for a rental vehicle.

While the invention has been described with reference to a specific preferred embodiment, the invention is certainly not limited to that precise embodiment. Rather, many modifications and variations will become apparent to persons of skill in the art without departure from the scope and spirit of this invention, as defined in the appended claims.

We claim:

1. Wireless interactive voice-actuated mobile information system, comprising
an on-board computer installed in a motor vehicle and including wireless means for connecting to the Internet while said vehicle is underway; a two-way voice technology circuit for communicating with a person in said vehicle and for converting spoken commands uttered by the person to electronic commands to be fed to the computer; at least one audio transducer coupled to said voice technology circuit; and a positioning and locating circuit coupled to said on-board computer; and
an interactive voice net central station connected via the Internet to communicate over said wireless means with said on-board computer; a plurality of commercial subscribers including a plurality of hospitality providers whose location is known relative to one or more principal roadways; each said subscriber having an automated computer facility maintaining an Internet connection with said central station; means for querying said on-board computer to obtain the geographical position and direction of travel of said motor vehicle; means for communicating via said voice technology circuit with the person in the vehicle to receive commands from him or her and to provide information and questions to him or her; and means for communicating hospitality reservation information over the Internet directly between one or more of said commercial subscribers and said person, hands-free, in said vehicle; and
wherein each said subscriber automated computer facility includes means for supplying said hospitality reservation information to said person automatically and unattended, so that human interface at the subscriber is avoided.

2. The wireless interactive voice-actuated mobile information system according to claim 1, wherein said commercial subscriber includes at least one restaurant on whose automated computer facility is stored a digital menu including a list of food menu items and associated prices in a form that can be communicated automatically over the Internet, and said on-board computer includes means for announcing to said person via said voice technology circuit said menu items and prices.

3. The wireless interactive voice-actuated mobile information system according to claim 1, wherein said commercial subscribers include at least one lodging provider, with said lodging provider having its automated computer facility directly connected, over the Internet, via said central station, to said on-board computer, and said automated computer facility includes means to provide said person in the vehicle directly with lodging availability and pricing in real time.

4. The wireless interactive voice-actuated mobile information system according to claim 3, wherein said automated computer facility includes means for automatically updating a room pricing schedule at said lodging facility, wherein prices for lodging space are automatically adjusted to optimize fill rate at said lodging provider.

5. The wireless interactive voice-actuated mobile information system according to claim 1, wherein said on-board computer is selectively operable in an on-demand mode and in a tracking mode, wherein in the on-demand mode the central station provides data from said subscribers only upon a request initiated by said person, and in the tracking mode the central station automatically and continuously delivers data from subscribers in the geographical area in which the person in the vehicle is traveling.

6. The wireless interactive voice-actuated mobile information system according to claim 1, wherein said central station also maintains a listing of non-subscriber hospitality providers, and makes available to the person in the vehicle only the name, location, and type of such non-subscriber hospitality providers.

7. The wireless interactive voice-actuated mobile information system according to claim 1, wherein said central station provides the person in the vehicle with names and driving directions to one or more of said hospitality providers that are located within a predetermined driving distance from the location of said vehicle.

8. The wireless interactive voice-actuated mobile information system according to claim 7, wherein said central station provides said person with hospitality reservation confirmation at a selected one of said hospitality providers.

9. The wireless interactive voice-actuated mobile information system according to claim 7, wherein said hospitality providers are classified in said central station according to type and said central station queries said person concerning a selection of the type of hospitality provider, accepts a voice selection of the type of provider, and then provides the person with the names and locations of the hospitality providers of that selected type.

10. The wireless interactive voice-actuated mobile information system according to claim 1, wherein said on-board computer includes input means coupled to speed, distance, and direction sensors in said motor vehicle.

11. The wireless interactive voice-actuated mobile information system according to claim 1, wherein said on-board computer includes voice-actuated printer means capable of printing out information concerning said one or more hospitality providers.

12. The wireless interactive voice-actuated mobile information system according to claim 1, further including means for contacting an emergency road service provider, over the Internet, and means for providing the emergency road service provider with the identity and location of said vehicle, and means for communicating to said person in the vehicle the identity and expected arrival time of such emergency road service provider.

13. The wireless interactive voice-actuated mobile information system according to claim 1, wherein said on-board computer includes means for creating a coded room key card for said person in the vehicle based on reservation information provided thereto in real time by a selected one of said hospitality providers.

14. The wireless interactive voice-actuated mobile information system according to claim 1, wherein said commercial subscribers include at least one lodging provider, with said lodging provider having its automated computer facility directly connected, over the Internet, via said central station, to said on-board computer, and said automated computer facility includes means to provide said person in the vehicle directly with room key coding data in real time so that the person can proceed directly to the space reserved for him or her at the lodging provider.

15. The wireless interactive voice-actuated mobile information system according to claim 1, wherein said on-board computer stores credit card data for the person in the vehicle so that credit-card transactions can be carried out automatically with a selected one of said subscribers; but said credit card data are not stored at the interactive voice net central station.
